(19) United States
(12) Patent Application Publication
(10) Pub. No.: US 2021/0187761 A1
(43) Pub. Date: Jun. 24, 2021

(54) DIRECTIONAL TILES FOR AUTONOMOUS DRONES

(71) Applicant: KLEWMEN LLC, San Diego, CA (US)

(72) Inventors: Ken V. LEW, San Diego, CA (US); Ken C. LEW, San Diego, CA (US)

(21) Appl. No.: 17/132,283

(22) Filed: Dec. 23, 2020

Related U.S. Application Data
(60) Provisional application No. 62/953,055, filed on Dec. 23, 2019.

(51) Int. Cl. B25J 19/02; B25J 9/16; G05D 1/02

(52) U.S. Cl. CPC B25J 19/023; G05D 1/0234; B25J 9/1697

(57) ABSTRACT

High strength carbon fiber tiles for autonomous drone navigation preferably are used where GPS and cellular navigation are limited or nonexistent, such as within buildings, subterranean, and non-terrestrial vehicles, in order to assist in monitoring and instructing drones to travel to predetermined locations. Tiles that are constructed out of carbon-fiber reinforced with graphene oxide nanoparticles in an epoxy resin coating provide a strong yet light-weight solution for covering areas where drone travel is desired. Contained within the tiles are navigational strips having LEDs or other lighting-emitting components, or having heating elements, which provide pathways for sensors to read and receive directional input for autonomous drone navigation. The tiles further preferably comprise 3D barcodes indicative of location in a mapped area to inform on drone location when traveling therein.

### COPYRIGHT STATEMENT

Any new and original work of authorship in this document is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The present invention generally relates to navigation of autonomous drones, robots, and other autonomous mobile apparatus (hereinafter generally referred to as “drones”). The present invention particularly relates to a novel approach to facilitating navigation of drones using tiles forming either a ceiling or a floor, or both. Representative drones that may be adapted for use in embodiments of the invention include those disclosed and suggested by the following U.S. patent references, each of which is incorporated herein by reference: U.S. patent application publication nos. 2017/0107055; 2018/0065258; 2019/0025849; and 2019/09352092.

It is believed that drones typically use either GPS or cellular communications for navigation, or use radar or other forms of electromagnetic reflection for navigation. By using navigational tiles in accordance with one or more aspects and features of the present invention, it is believed that drawbacks associated with such conventional navigation are overcome. Moreover, preferred navigational tiles in accordance with one or more aspects and features of the present invention exhibit high strength, even under extreme temperatures, and are particularly suited for such applications.

### SUMMARY OF THE INVENTION

The present invention includes many aspects and features. Moreover, while many aspects and features relate to, and are described in, the context of tiles used for drone navigation, the present invention is not limited to use only in such contexts, as will become apparent from the following summaries and detailed descriptions of aspects, features, and one or more embodiments of the present invention. Indeed, tiles of the invention may be used apart from drone navigation, including used for decorative purposes and used to form walls rather than floors and ceilings, and may be utilized without facilitating or enabling autonomous navigation of drones.

Accordingly, in an aspect of the invention, a tile comprises a tile body and a high-strength carbon-fiber plate attached to a surface of the tile body, the carbon-fiber plate comprising a cured coating of an epoxy resin with graphene oxide nanoparticles mixed therein.

In a feature, the tile body comprises aluminum and, preferably, aluminum 6061.

In a feature, the tile further comprises a plurality of LEDs configured to illuminate a pathway for a light wave-detecting sensor.

In a feature, the tile further comprises a plurality of light-emitting components configured to illuminate a pathway for a light wave-detecting sensor.

In a feature, the tile further comprises a plurality of heat-generating components configured to illuminate a pathway for a heat-detecting sensor.

In a feature, the tile further comprises a strip of LEDs configured to illuminate a pathway for a light wave-detecting sensor.

In a feature, the tile further comprises a strip of light-emitting components configured to illuminate a pathway for a light wave-detecting sensor.

In a feature, the tile further comprises a strip of heat-generating components configured to illuminate a pathway for a heat-detecting sensor.

In a feature, the tile further comprises a strip of heat-generating components configured to illuminate a pathway for a thermal sensor.

In a feature, the tile further comprises a strip of LEDs configured to illuminate a pathway for a color-detecting sensor.

In another aspect, a tile comprises a tile body and having a tile surface, wherein the tile body defines channel extending from a first side of the tile to a second side of the tile.

In a feature, the first side and second side of the tile are opposite sides of the tile.

In a feature, the tile comprises a marker on the tile surface.

In a feature, the tile comprises on the tile surface a 3D bar code indicative of a location of the tile within a mapped area.

In a feature, a navigational strip extends within the channel from the first side to the second side of the tile.

In related features, the navigational strip comprises a connector at each end thereof for connections to other navigational strips; and the navigational strip comprises one or more controllers or switches that control actuation of the navigational strip.

In another related feature, the navigational strip is configurable for selectively illuminating a pathway when actuated. The pathway that is selectively illuminated is along the entire extent of the navigational strip between sides of the tile body, or alternatively, the pathway that is selectively illuminated is along only a small portion of the entire extent of the navigational strip between sides of the tile body. Preferably, a plurality of LEDs illuminate the pathway; or the pathway is illuminated through generation of heat, which heat may be generated from electrical resistance. In this latter respect, thermal wire preferably is used in the navigational strip for generating heat.

In another feature, the tile further comprises a reinforcing layer located on top of the tile body, which reinforcing layer forms the surface of the tile. The reinforcing layer may further cover surfaces of the channel but does not block or otherwise inhibit access to the channel for inserting or removing one or more navigational strips. The reinforcing layer may comprise a high-strength carbon-fiber weave having an epoxy resin coating that includes graphene oxide nanoparticles; and the reinforcing layer may comprise a carbon-fiber plate having an epoxy resin-graphene oxide coating. The tile also may further comprise an additional layer located on top of the reinforcing layer, which additional layer forms the surface of the tile and serves to protect the reinforcing layer. The additional layer preferably comprises a sheet of thermoplastic acrylic-polyvinyl chloride.

In a feature, the tile body comprises an aluminum 6061 plate.

In a feature, the tile further comprises a navigational strip that extends within the channel from the first side to the second side of the tile, and wherein the navigational strip is located below the tile surface, whereby the navigational strip does not support loading of the tile.

In another aspect, an arrangement of tiles, each in accordance with one or more foregoing aspects and feature, includes a single navigational strip is located within connecting channels of the tiles, which strip extends the length of the channels. The arrangement of tiles forms a ceiling or a floor.

In another aspect, a method of making a tile comprises mixing graphene oxide with an epoxy resin; applying the resulting mixture to a carbon-fiber weave to coat the carbon-fiber weave; and arranging the carbon-fiber weave on a tile body surface.

In a feature, the coated carbon-fiber weave is cured and adhered to the tile surface. A sheet of thermoplastic acrylic-polyvinyl chloride preferably is adhered to the surface of the coated carbon-fiber weave.

In another feature, the step of arranging the carbon-fiber weave on a tile body surface is performed such that access to a channel that is defined in the tile body surface is not obstructed.

In another feature, the method further comprises locating a navigational strip within the channel so as to extend from a first side to a second side of the tile.

In another feature, the method further comprises permanently locating a navigational strip within the channel so as to extend from the first side to the second side of the tile. The navigational strip may be embedded within a transparent or translucent material within the channel defined in the tile body.

In another aspect, a method of making a tile for use in autonomous drone navigation comprises: mixing graphene oxide with an epoxy resin; applying the resulting mixture to a carbon-fiber weave; providing a tile body having a surface with a channel defined therein extending from a first side of the tile to a second side of the tile; curing the carbon-fiber weave; arranging the carbon-fiber weave such that the surface of the tile body is covered by the carbon-fiber weave without obstructing access to the channel; and adhering the carbon-fiber weave to the surface of the tile body.

In another aspect, a method of making a tile for use in autonomous drone navigation comprises: mixing graphene oxide with an epoxy resin; applying the resulting mixture to a carbon-fiber weave; providing a tile body having a surface with a channel defined therein extending from a first side of the tile to a second side of the tile; curing the carbon-fiber weave; arranging the carbon-fiber weave such that the surface of the tile body is covered by the carbon-fiber weave without obstructing access to the channel; and adhering the carbon-fiber weave to the surface of the tile body.

In a feature, the carbon-fiber weave forms a carbon-fiber plate when the applied epoxy resin-graphene oxide mixture is cured.

In a feature, the method further comprises adhering a sheet of thermoplastic acrylic-polyvinyl chloride sheet over the carbon-fiber weave. Preferably, the sheet is a Kydex sheet.

In a feature, the method further comprises locating a navigational strip within the channel to extend from the first side to the second side of the tile.

In a feature, the method further comprises permanently locating—and preferably embedding within a transparent or translucent material—a navigational strip within the channel so as to extend from the first side to the second side of the tile.

In a feature, the method further comprises removably locating—and preferably simply inserting—a navigational strip within the channel so as to extend from the first side to the second side of the tile.

In a feature, the navigational strip comprises a connector at an end thereof that is configured to connect with another connector of another navigational strip located in another tile.

In a feature, the navigational strip comprises a connector at each end thereof that is configured to connect with another connector of another navigational strip located in another tile.

In a feature, the connector is located within and extends from a side of the tile body.

In a feature, the navigational strip is configurable to selectively illuminate a pathway when actuated. Preferably, the pathway is illuminated by heat or light that is electrically generated along the strip. Light preferably is electrically generated by LEDs or other light-emitting components; heat preferably is electrically generated through electrical resistance; and the range and degree of heat or the range and intensity of light generated preferably is sufficient to be reliably detected by a sensor arrangement of a navigating drone.

In a feature, the channel extends between opposite sides of the tile body.

In a feature, the channel extends between adjacent sides of the tile body.

In a feature, the channel extends between three sides of the title body.

In a feature, the channel extends between four sides of the title body.

In a feature, the title is rectangular.

In a feature, the tile is square.

In a feature, the tile surface comprises a marker indicating a location within a mapped area.

In a feature, the tile surface comprises a 3D bar code.

In another aspect, a drone configured to travel across a pathway comprises a sensor arrangement for detecting the pathway.

In a feature, the sensor arrangement is configured to detect different light waves. The light waves detected may be within infrared, visible, or ultraviolet ranges, or combinations thereof.

In a feature, the drone further comprises a sensor arrangement for reading a marker that indicates a location within a mapped location. Preferably, the marker comprises a 3D bar code.

In a feature, the sensor is configured to detect different ranges of heat.

Another aspect comprises a navigation tile made from the aforementioned method.

In another aspect, a system comprise a floor or ceiling formed from a plurality of navigational tiles of the aforementioned aspect.

In a feature, navigational tiles are connected to form the floor or ceiling.

In a feature, navigational strips are connected between adjacent tiles.

In a feature, a navigational strip extends within channels of two or more tiles.

In a feature, a dispatch system is configured to cause a first plurality of navigational tiles to illuminate a pathway, which pathway preferably leads to a predetermined location for performing a task by a drone.

In a feature, a dispatch system is configured to cause a first plurality of navigational tiles to illuminate a first pathway and a second plurality of navigational tiles to illuminate a second pathway. Preferably, the dispatch system is disposed in electronic communication with—whether wired, wireless, or combination thereof—controllers or switches of the navigational strips of the navigational tiles for controlling the pathways that are illuminated by the navigational strips.

In a feature, one or more drones are configured to traverse illuminated pathways of the navigational tiles.

Another aspect comprises a drone configured to navigate a ceiling or floor that is formed by a plurality of tiles each in accordance with any of the foregoing aspects or features.

Yet another aspect comprises a drone configured to navigate a ceiling or floor that is formed by a plurality of tiles made by any of the foregoing aspects or features relating to a method for making a tile.

Additional aspects and features are disclosed in the appendix to the specification, which is incorporated herein by reference. Pictures and a chart and tables are taken from the appendix and included as FIGS. 17-21 for clarity.

In addition to the aforementioned aspects and features of the present invention, it should be noted that the present invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the present invention now will be described in detail with reference to the accompanying drawings, wherein the same elements are referred to with the same reference numerals.

FIG. 1 is a top plan view of a tile in accordance with one or more aspects and features of the invention.

FIG. 2A is a cross-sectional view of the tile of FIG. 1 taken along the line A-A in FIG. 1.

FIG. 2B is a cross-sectional view similar to that of FIG. 2A of an alternative tile in accordance with one or more aspects and features of the invention.

FIG. 2C is a cross-sectional view of the tile of FIG. 1 taken along the line B-B in FIG. 1.

FIG. 3 is a top schematic view of another arrangement of tiles in which a navigational strip extends across a plurality of adjacent tiles.

FIG. 4 a top plan view of another tile in accordance with one or more aspects and features of the invention.

FIG. 5A is a top plan view of another tile in accordance with one or more aspects and features of the invention, wherein the tile is in a first orientation.

FIG. 5B is a top plan view of the tile of FIG. 5A in a second orientation.

FIG. 6A is a top plan view of another tile in accordance with one or more aspects and features of the invention, wherein the tile is in a first orientation.

FIG. 6B is a top plan view of the tile of FIG. 6A in a second orientation.

FIG. 6C is a top plan view of the tile of FIG. 6A in a third orientation.

FIG. 6D is a top plan view of the tile of FIG. 6A in a fourth orientation.

FIG. 7A is a top plan view of another tile in accordance with one or more aspects and features of the invention, wherein the tile is in a first orientation.

FIG. 7B is a top plan view of the tile of FIG. 7A in a second orientation.

FIG. 7C is a top plan view of the tile of FIG. 7A in a third orientation.

FIG. 7D is a top plan view of the tile of FIG. 7A in a fourth orientation.

FIG. 8A is a side schematic view of a drone in accordance with one or more aspects and features of the invention.

FIG. 8B is a bottom schematic view of the drone of FIG. 8A.

FIG. 9A is a side schematic view of another drone in accordance with one or more aspects and features of the invention.

FIG. 9B is a top schematic view of the drone of FIG. 9A.

FIG. 10 is an illustration of an exemplary warehouse utilizing a system in accordance with one or more aspects and features of the invention.

FIG. 11A is a top schematic view of a system in accordance with one or more aspects and features of the invention, including a drone in a first position and an arrangement of tiles defining a pathway along which the drone navigates.

FIG. 11B is a top schematic view of the system of FIG. 11A, wherein the drone has advanced to a second position along the pathway defined by the tiles.

FIG. 11C is a top schematic view of the system of FIG. 11A, wherein the drone has advanced to a third position along the pathway defined by the tiles.

FIG. 11D is a top schematic view of the system of FIG. 11A, wherein the drone has rotated itself for making a turn along the pathway defined by the tiles.

FIG. 11E is a top schematic view of the system of FIG. 11A, wherein the drone has rotated itself for making a turn along the pathway defined by the tiles.

FIG. 11F is a top schematic view of the system of FIG. 11A, wherein the drone has rotated itself for making a turn along the pathway defined by the tiles.

FIG. 11G is a top schematic view of the system of FIG. 11A, wherein the drone has rotated itself for making a turn along the pathway defined by the tiles.

FIG. 11H is a top schematic view of the system of FIG. 11A, wherein the drone has rotated itself for making a turn along the pathway defined by the tiles.

FIG. 12 is a top schematic view of another system in accordance with one or more aspects and features of the invention, including an arrangement of tiles forming a ceiling for defining a plurality of pathways along (under) which one or more drones may navigate.

FIG. 13 is a photograph of a prototype tile with a navigational strip extending across and beyond the tile.

FIG. 14 is a photograph of the prototype tile of FIG. 13 without the navigations strip.

FIG. 15 is a photograph of a close-up perspective view of a corner of the tile of FIG. 14.

FIG. 16 is a flowchart of a method of manufacturing a tile in accordance with one or more aspects and features of the invention.

FIG. 17 is a photograph taken from the appendix and reproduced for clarity in the drawings, which photograph shows a perspective view of an aluminum block being milled to form a “+” channel therein during manufacture of a tile in accordance with one or more aspects and features of the invention.

FIG. 18 is a photograph taken from the appendix and reproduced for clarity in the drawings, which photograph shows a perspective view of the aluminum block of FIG. 17 following milling and following the placement of one or more carbon-fiber sheets on a surface thereof, each sheet having been coated with an epoxy resin mixed with graphene oxide and cured; it will be appreciated from viewing FIG. 18 that, in this representative tile, the carbon-fiber sheets cover not only the surface of the tile body, but also cover the channel surfaces without blocking access to the channel for insertion or removal of one or more navigational strips from the channel.

FIG. 19 is a chart from the appendix reproduced for clarity in the drawings.

FIG. 20 is a table from the appendix reproduced for clarity in the drawings.

FIG. 21 is another table of the appendix reproduced for clarity in the drawings.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Referring now to the drawings, one or more preferred embodiments of the invention are next described. The following description of one or more preferred embodiments is merely exemplary in nature and is in no way intended to limit the invention, its implementations, or uses.

As set forth above, the present invention generally relates to navigation of autonomous drones and, in particular, navigation of autonomous drones using tiles in accordance with one or more aspects and features of the invention. Such tiles form either a flooring or a ceiling, or both, and collectively define one or more pathways for drone navigation to predetermined locations or along predetermined routes. The navigational tiles also may provide navigational commands to the drones, such as “stop” or “go” similar to a stoplight, and the navigational tiles also may provide location information. For example, a tile may comprise 3D barcodes to indicate location and provide feedback to computer-monitored systems to inform on drone location when traveling within a mapped area.

Use of navigational tiles in accordance with one or more aspects and features of the invention are believed to be particularly beneficial in areas where GPS or cellular communications is limited or nonexistent, including for example and not by way of limitation, areas such as within buildings, within subterranean areas, within submerged locations, on submerged vehicles, and on non-terrestrial vehicles. The tiles further can be used in areas lacking visible light, including within areas such as warehouses or buildings that have operations running continuously 24 hours each day, 365 days each year. The directional tiles further may form part of a safety system, providing navigation in locations where visibility—normally present—is impaired due to smoke or otherwise.

Preferred tiles comprise high-strength carbon-fiber tiles and, in particular, tiles constructed from carbon fiber having an epoxy resin coating comprising graphene oxide (“GO”) nanoparticles. The use of GO nanoparticles provides for an unexpectedly strong yet light-weight tile. Preferably LED strips or heating elements are located within the tiles in the form of illuminating strips which pathways are detectable by color and/or thermal sensors.

It has been determined through laboratory testing that tinsel strength of a carbon-fiber weave is immensely boosted when a coating of about 2% GO by volume mixture of high temperature epoxy resin is applied and then cured under temperature. Use of such high-strength carbon-fiber weave, preferably formed into a carbon-fiber plate, as a layer of a tile is believed to beneficial, as such reinforced tiles may support a person's weight as well as the weight of drones and materials carried by drones.

In addition, carbon-fiber weave samples cured with the epoxy resin-GO mixture have shown no degradation in yield stress under extreme condition at or exceeding 300 degrees Fahrenheit—the equivalent of fire conditions. Both heated and room temperature carbon-fiber samples having dimensions of 3″×1″×0.128″ were tested using a universal testing machine capable of measuring up to 10,000 lbf. The results show that adding a first curing step at 80 degrees Fahrenheit and a second curing step at 311 degrees Fahrenheit increases the tensile strength of the carbon-fiber sample to 368.18 MPa at room temperature, and to 194.76 MPa at 300 degrees Fahrenheit, which is higher than comparable samples of Titanium alloys. It is believed that similar advantages can be obtained with tiles reinforced with such high-strength carbon-fiber weave.

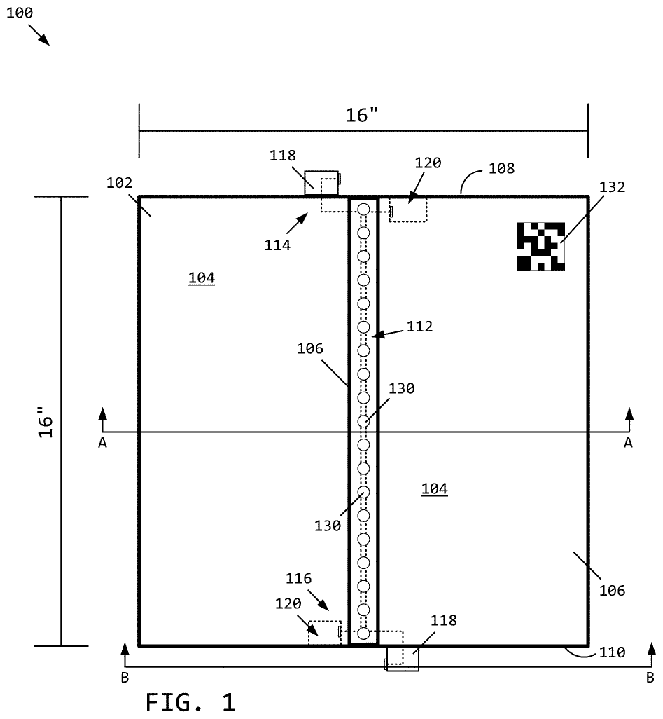

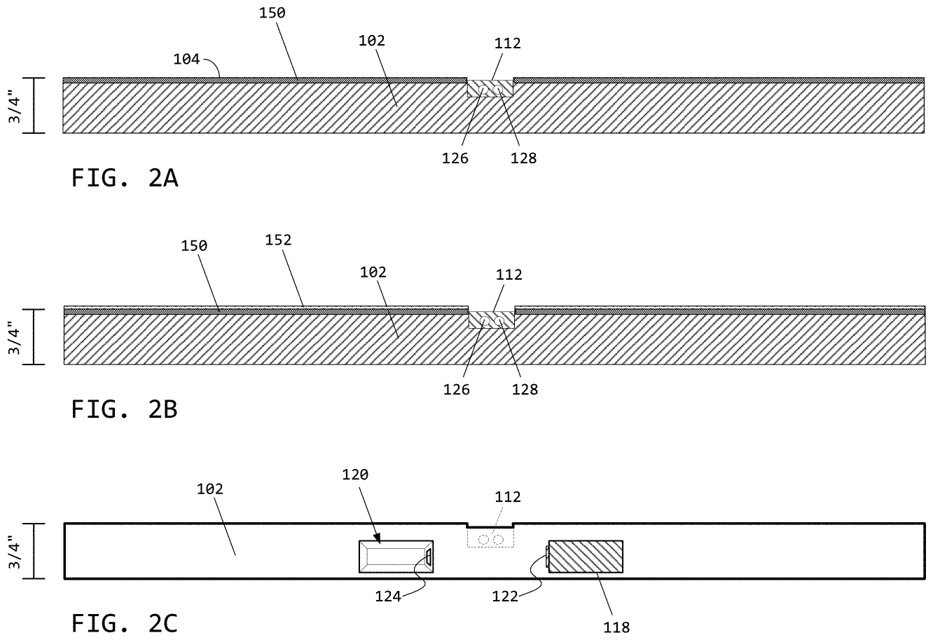

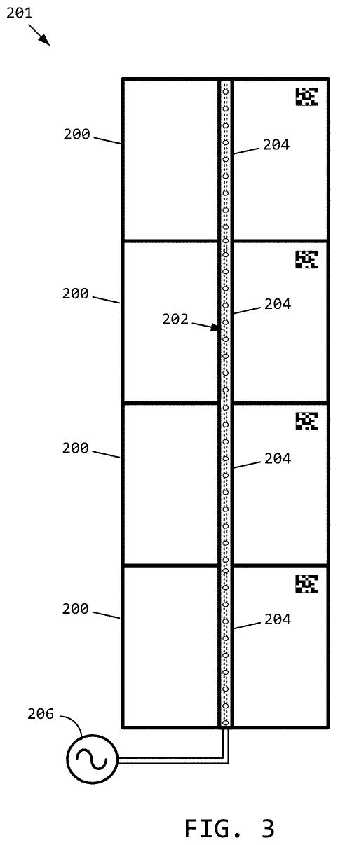

Turning now to FIG. 1, a top plan view of a tile 100 is shown in accordance with one or more aspects and features of the invention. The preferred tile 100 comprises a square tile body 102 that is 16 inches by 16 inches in length and width, and 0.75 inches in thickness (as seen in FIGS. 2A and 2C). Other dimensions of the tile may be used; these dimensions are only illustrative. The tile 100 further has a tile surface 104 and a channel 106 defined in the tile body 102 extending from a first side 108 of the tile 100 to a second side 110 of the tile 100. As see in FIG. 1, the first side 108 and second side 110 of the tile 100 are opposite sides of the tile 100.

As seen in FIG. 1, the tile 100 further include on the surface 104 a marker in the form of a 3D bar code 132, which preferably indicates or provides information regarding a location of the tile 100 within a mapped area.

A navigational strip 112 extends within the channel 106 from the first side 108 to the second side 110 of the tile 100. The navigational strip 112 comprises a connector 114,116 at each end thereof. Each connector 114,116 is configured to connect with another similar connector of another navigational strip that is located in another tile when the tiles are connected to form a floor or ceiling.

In particular, each connector 114,116 includes a male component 118 and a female component 120. When connectors are connected together, the male component 118 of a first one of the connectors is received within the female component 120 of the other connector, and the female component 120 of the first one of the connectors receives the male component 118 of the other connector. When so connected together, an electrical contact 122 of a male component 118 engages an electrical contact 124 of a female component 120 for electrically connecting two navigational strips. The electrical contacts 122,124 are perhaps best seen in FIG. 2C.

It will be appreciated from FIG. 1 that the connectors 114,116 are located within and extend from the tile body 102. Specifically, male component 118 extends from the tile body 102 and the female component 120 comprises a recess formed in the tile body 102 that is configured to receive in frictional fit therewith a corresponding male component 118.

The navigational strip 112 is seen in the cross-sectional view in FIG. 2A, which is taken along the line A-A in FIG. 1. As seen in FIG. 2A, the navigational strip 112 includes parallel electrical conduits preferably in the form of wires 126,128 for carrying electric current. The tile 100 further preferably comprises controllers or switches (not shown) that control actuation of LEDs 130 (FIG. 1) or other lighting components by the electric current, whereby the navigational strip 112 is configurable for selectively illuminating a pathway when actuated. The pathway that is selectively illuminated may be along the entire extent of the navigational strip between sides of the tile body, or only partially along such extent. Rather than using LEDs to illuminate the pathway, the pathway may be illuminated through the generation of heat generated from, for example, electrical resistance. The range and degree of heat, or the range and intensity of light generated, for illuminating the pathway preferably is sufficient to be reliably detected by a sensor arrangement of a navigating drone.

Also seen in the cross-sectional view of FIG. 2A is the construction of the tile 100. In particular, a reinforcing layer 150 is located on top of the tile body 102, which reinforcing layer 150 forms the surface 104 of the tile 100. The reinforcing layer 150 preferably comprises a high-strength carbon-fiber weave having an epoxy resin coating that includes graphene oxide (“GO”) nanoparticles. The carbon-fiber weave further preferably forms a carbon-fiber plate when the applied epoxy resin-graphene oxide mixture is cured.

An alternative embodiment of the tile 100 is seen in the cross-sectional view in FIG. 2B, wherein the same structures are called out with the same reference numbers. The difference of the tile of FIG. 2B over the tile 100 of FIG. 2A is the additional layer 152 located on top of the reinforcing layer 150. The additional layer 152 instead of the reinforcing layer 150 forms the surface 104 of the tile and serves to protect the reinforcing layer 150. Preferably, the additional protective layer 152 comprises a sheet of thermoplastic acrylic-polyvinyl chloride such as, for example, a Kydex sheet.

FIG. 2C is a cross-sectional view of the tile 100 of FIG. 1 taken along the line B-B in FIG. 1. The components 118,120 of the connector 116—including the electrical contacts 122,124—are perhaps best seen in FIG. 2C.

It will be appreciated from inspection of FIGS. 2A and 2B that the top of the navigational strip 112 is located below the tile surface 104. This is preferred because the tile surface is reinforced by layer 150 and supports loading of the tile 100. Preferably, the navigational strip 112 does not support loading of the tile 100 and, therefore, is located at a spacing below the tile surface 104 so as to avoid any load that is placed upon the tile 100.

FIG. 3 is a top schematic view of an arrangement 201 of tiles 200. Unlike tile 100, each of tiles 200 lacks connectors of a navigational strip. Instead, a single navigational strip 202 is located within connecting channels 204 of the tiles 200, which strip 202 extends the length of the channels 204. The strip 202 itself preferably comprises connectors (not shown) on its opposite ends for electrical connection to other navigational strips or, as seen in FIG. 3, to an electrical power source 206. Additionally, the navigational strip 202 preferable comprises controllers or switches (not shown) by which the navigational strip 202 is configurable for selectively illuminating a pathway when actuated.

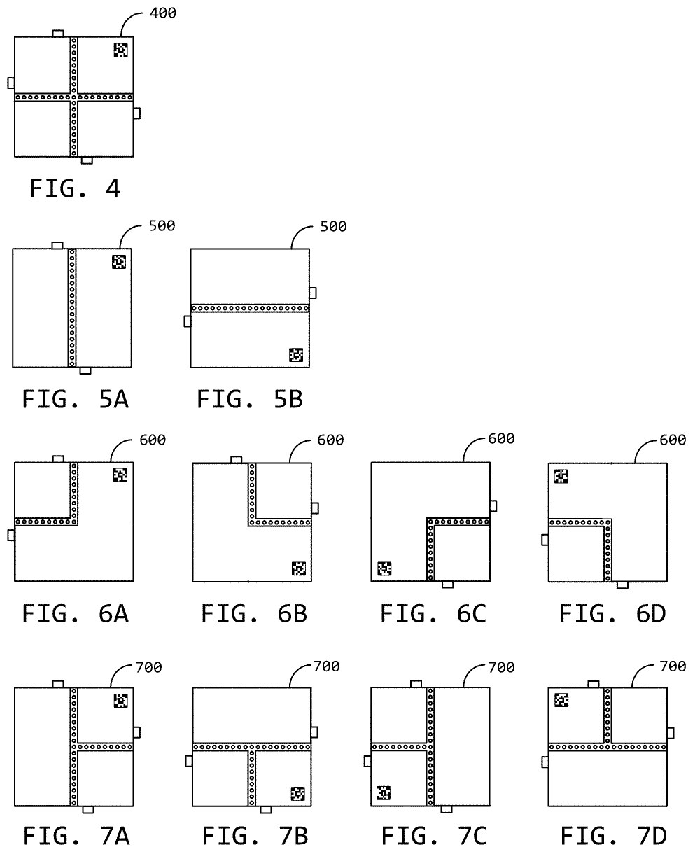

FIG. 4 a top plan view of another tile 400 in accordance with one or more aspects and features of the invention. This tile 400 is similar in structure to tile 100 with the exception that the channel of tile 400 extends between all four sides of the tile 400, which is rectangular as shown. Preferably, the channel is in the form of a plus sign “+”, i.e., two bisecting orthogonal line segments.

FIG. 5A is a top plan view of another tile 500 in accordance with one or more aspects and features of the invention, wherein the tile 500 is seen in a first orientation. This tile 500 is similar in structure to and representative of tile 100, wherein the channel bisects the tile, extending between only two, opposite sides of the four sides.

FIG. 5B is a top plan view of the tile 500 of FIG. 5A, wherein the tile 500 is seen in a second orientation.

FIG. 6A is a top plan view of another tile 600 in accordance with one or more aspects and features of the invention, wherein the tile 600 is seen in a first orientation. This tile 600 is similar in structure to tile 100 with the exception that the channel of tile 600 extends between two adjacent sides of the four sides of the rectangular tile 600, sectioning off a quadrant of the surface of the tile 600.

FIG. 6B is a top plan view of the tile 600 of FIG. 6A seen in a second, different orientation.

FIG. 6C is a top plan view of the tile 600 of FIG. 6A seen in a third, different orientation.

FIG. 6D is a top plan view of the tile 600 of FIG. 6A seen in a fourth, different orientation.

FIG. 7A is a top plan view of another tile 700 in accordance with one or more aspects and features of the invention, wherein the tile is seen in a first orientation. This tile 700 is similar in structure to tile 100 with the exception that the channel of tile 700 extends between two adjacent sides and one intermediate side of the four sides of the rectangular tile 700, sectioning off half and two quadrants of the surface of the tile 700.

FIG. 7B is a top plan view of the tile 700 of FIG. 7A seen in a second, different orientation.

FIG. 7C is a top plan view of the tile 700 of FIG. 7A seen in a third, different orientation.

FIG. 7D is a top plan view of the tile 700 of FIG. 7A seen in a fourth, different orientation.

It will be appreciated that, based on a rectangular tile and varying the points of electrical connection as between the four sides of the rectangular tile, eleven different pathway tile segments are provided for use in an arrangement of such tiles to form a ceiling or a floor in a preferred system of the invention for navigation of drones.

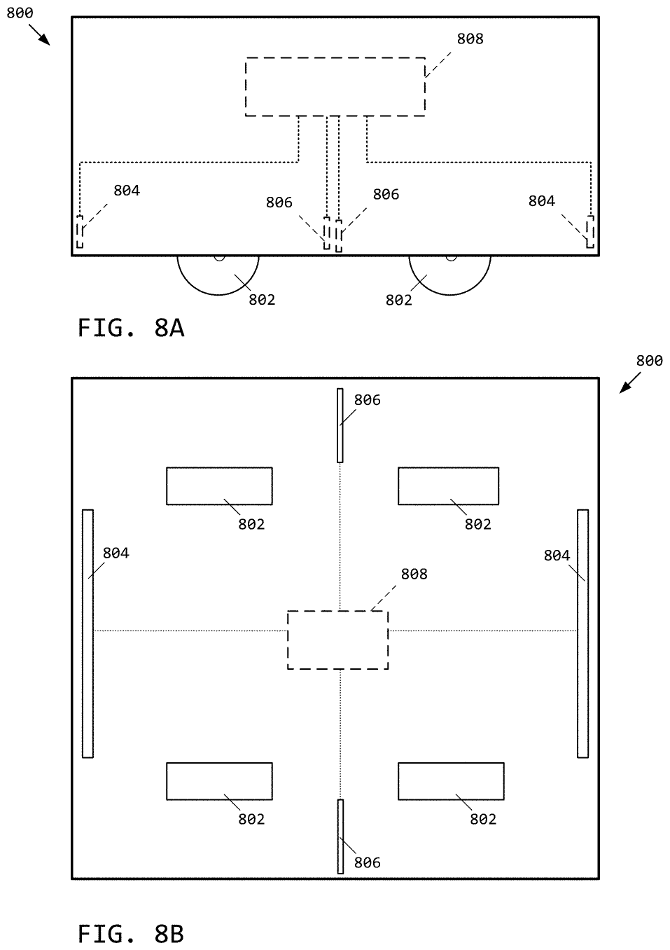

With respect to such a system, a preferred drone 800 is represented in the schematic views of FIGS. 8A and 8B, which drone 800 detects and follows pathways illuminated along a floor. The drone 800 comprises wheels 802 for traversing the floor; sensors 804 for detecting illuminated pathways along the floor; sensors 806 for reading the markers indicating location; and a control unit 808 in electrical communication with the sensors 806,808 for processing sensor data and for controlling movement and navigation of the drone 800. The sensors 804 preferably are configured to detect different light waves. The light waves detected may be within infrared, visible, or ultraviolet ranges, or combinations thereof. Alternatively, the sensors 804 are configured to detect different ranges of heat.

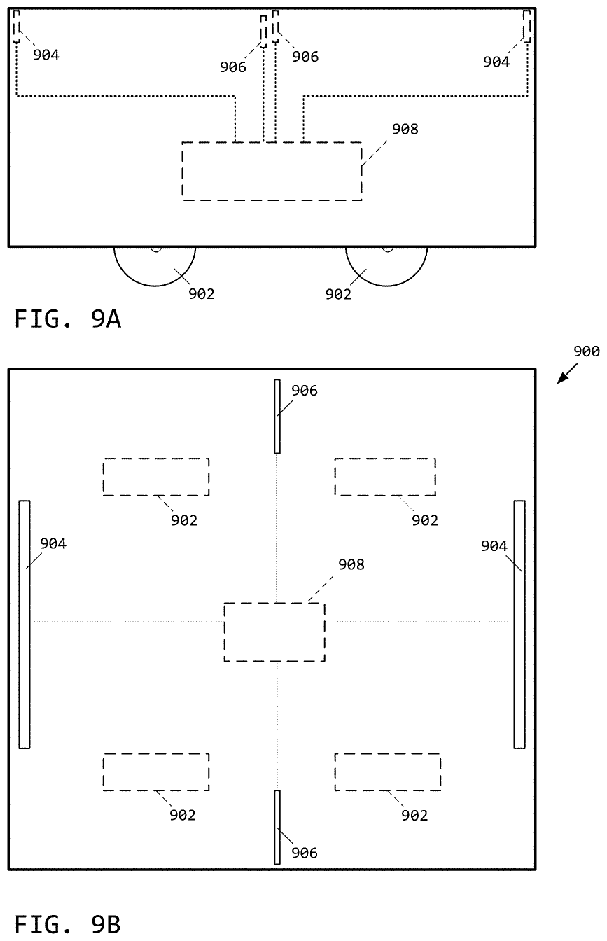

A preferred drone 900 is represented in the schematic views of FIGS. 9A and 9B, which drone 900 detects and follows pathways illuminated along a ceiling. The drone 900 comprises wheels 902 for traversing the floor; sensors 904 for detecting illuminated pathways along the ceiling; sensors 906 for reading the markers indicating location; and a control unit 908 in electrical communication with the sensors 906,908 for processing sensor data and for controlling movement and navigation of the drone 900. The sensors 904 preferably are configured to detect different light waves. The light waves detected may be within infrared, visible, or ultraviolet ranges, or combinations thereof. Alternatively, the sensors 904 are configured to detect different ranges of heat.

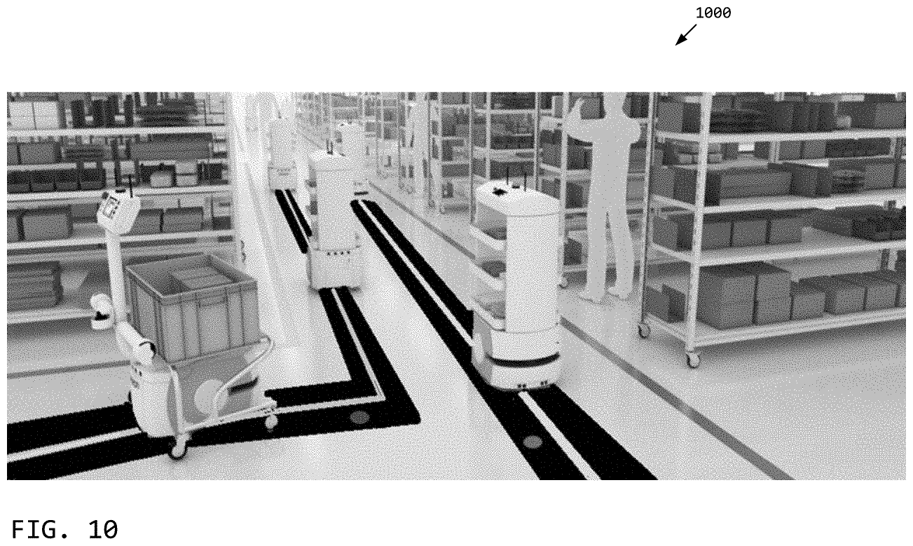

FIG. 10 is an illustration of a warehouse utilizing a system 1000 in accordance with one or more aspects and features of the invention, and is generally representative of what a preferred implementation of a system of the invention might resemble.

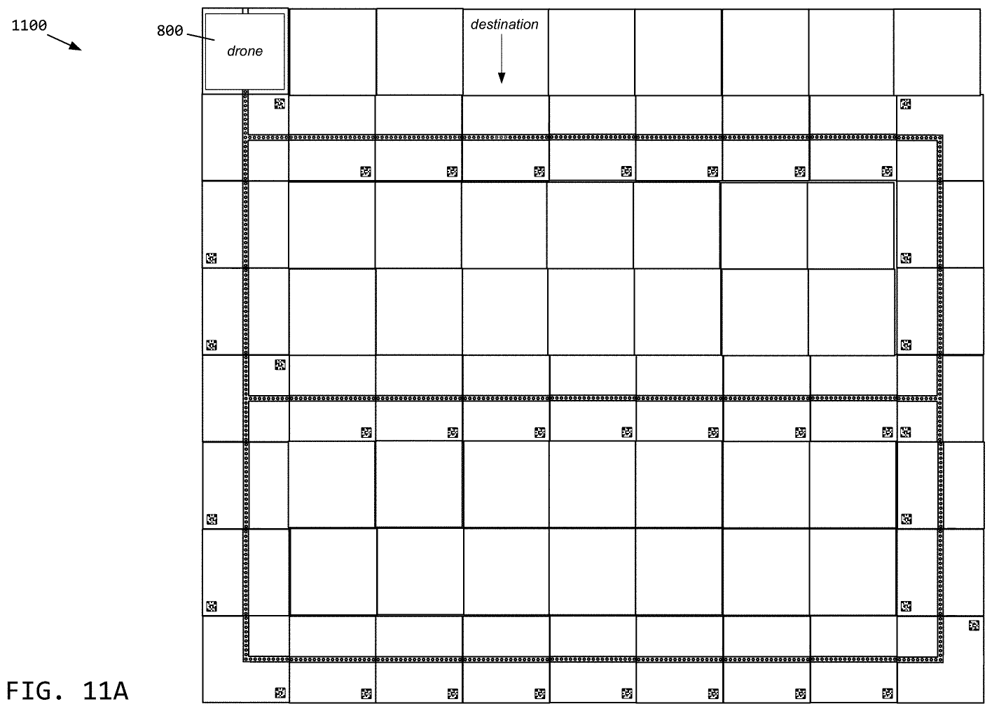

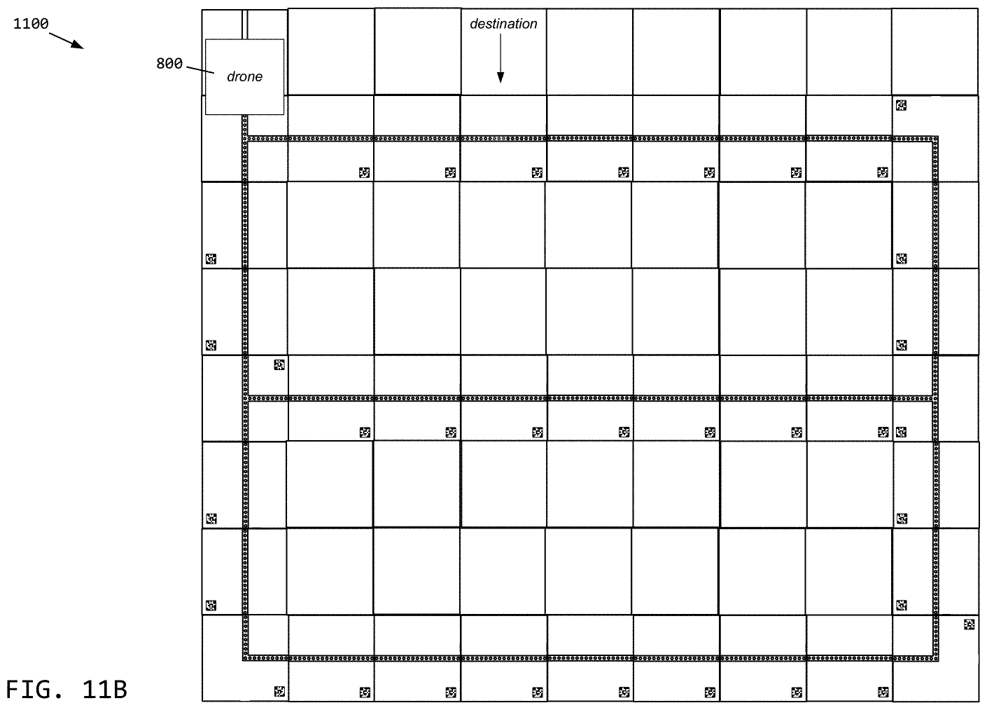

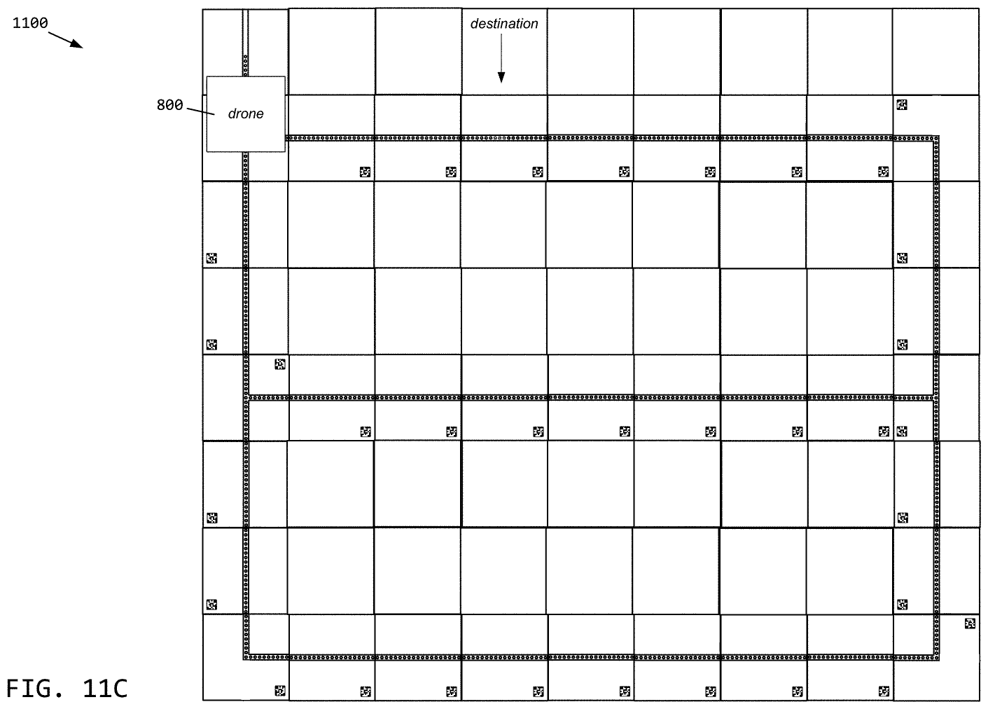

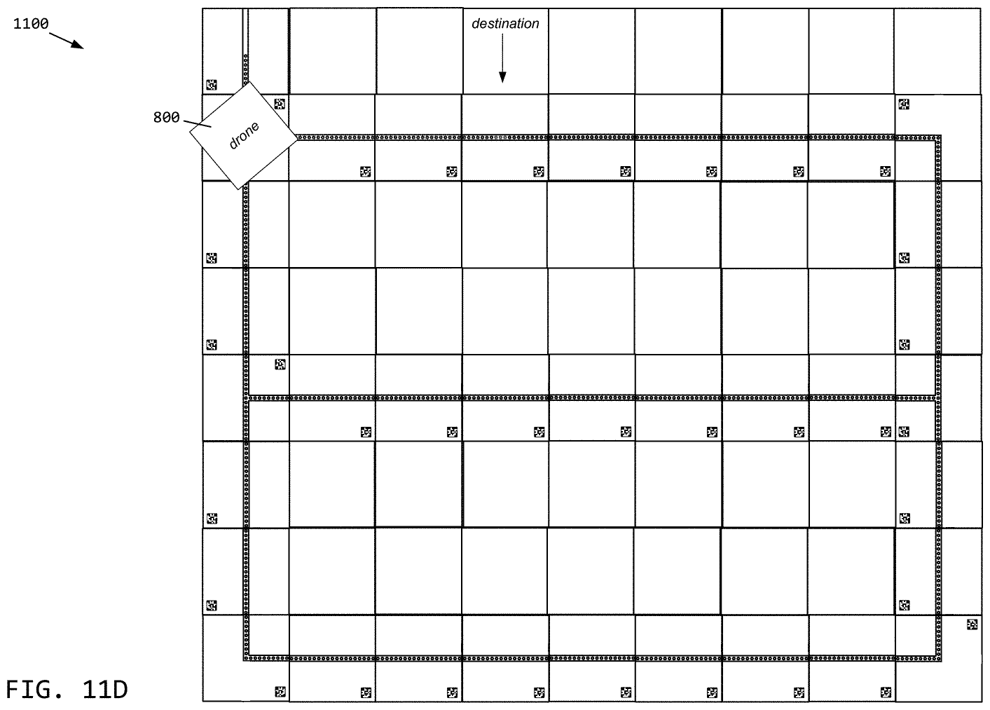

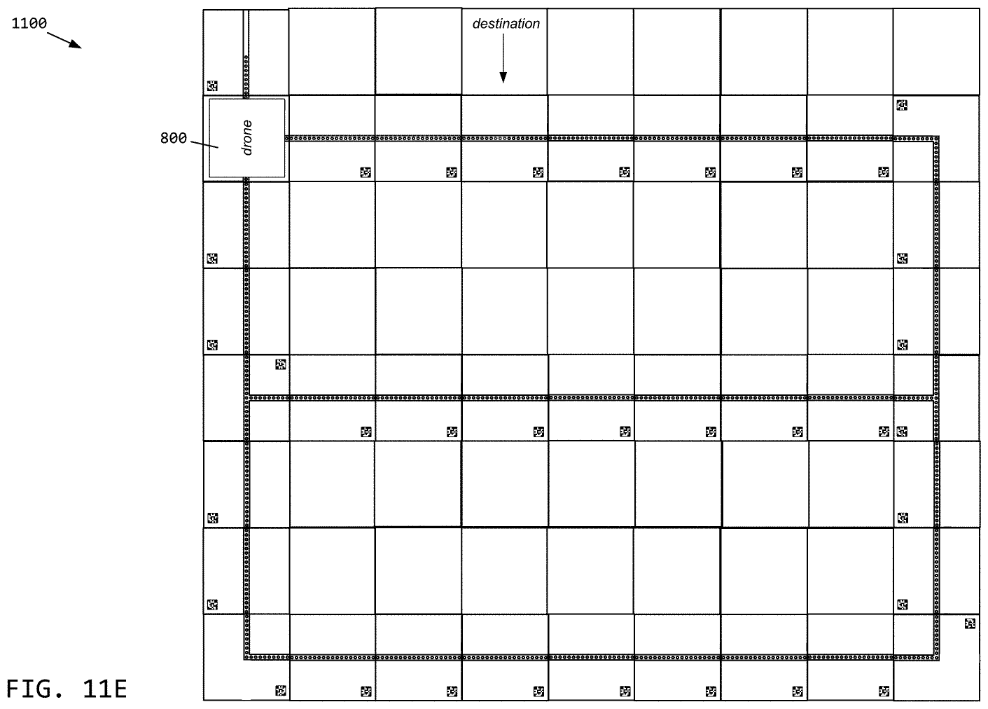

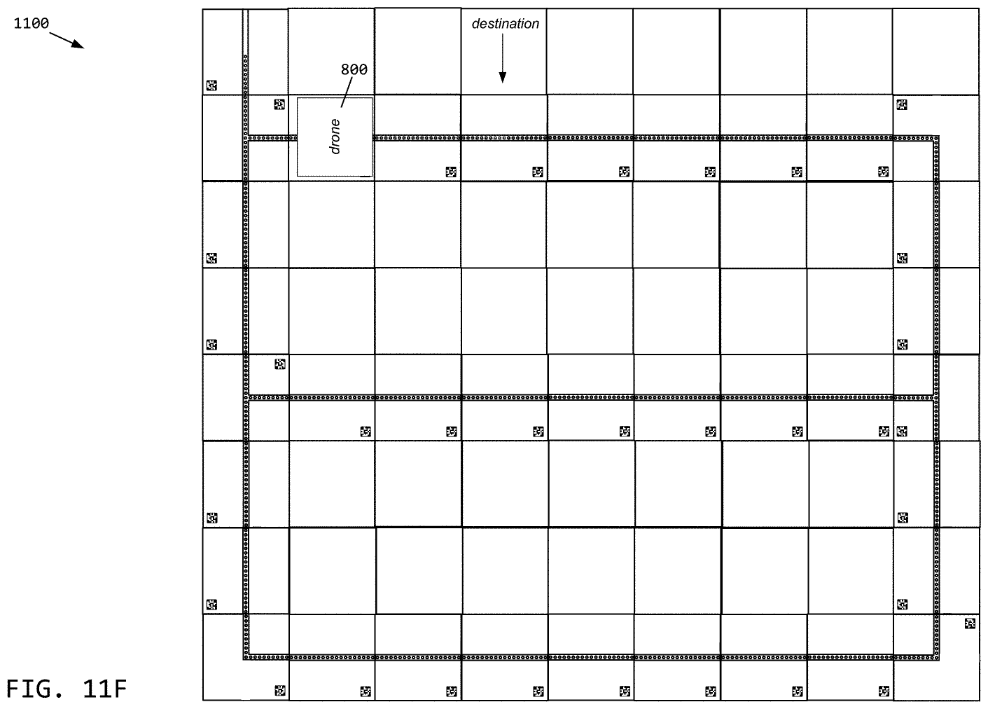

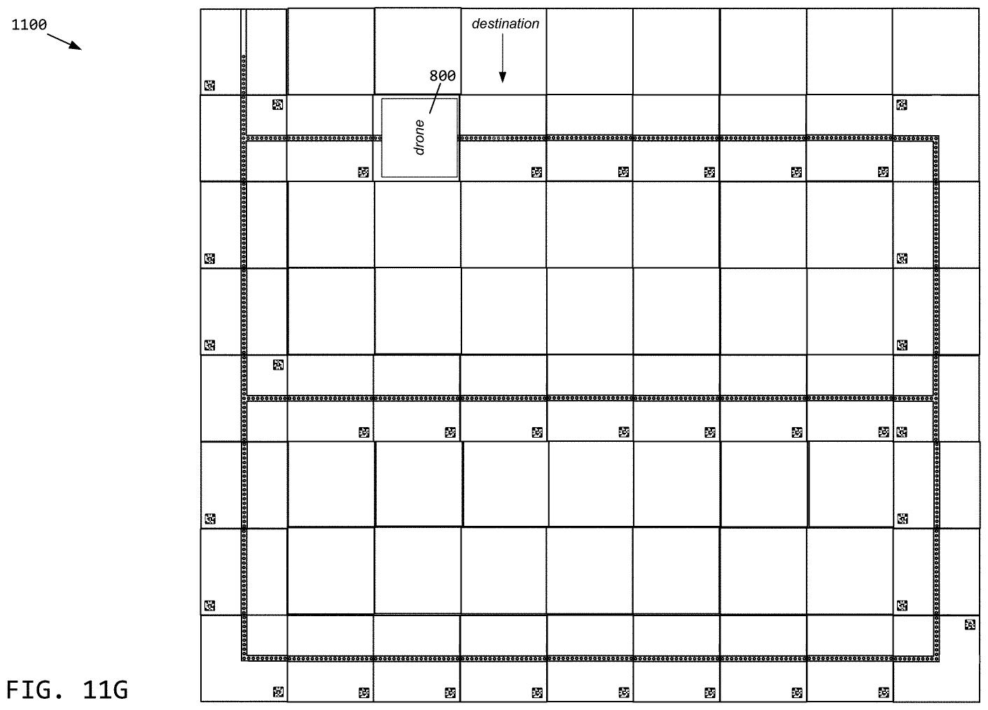

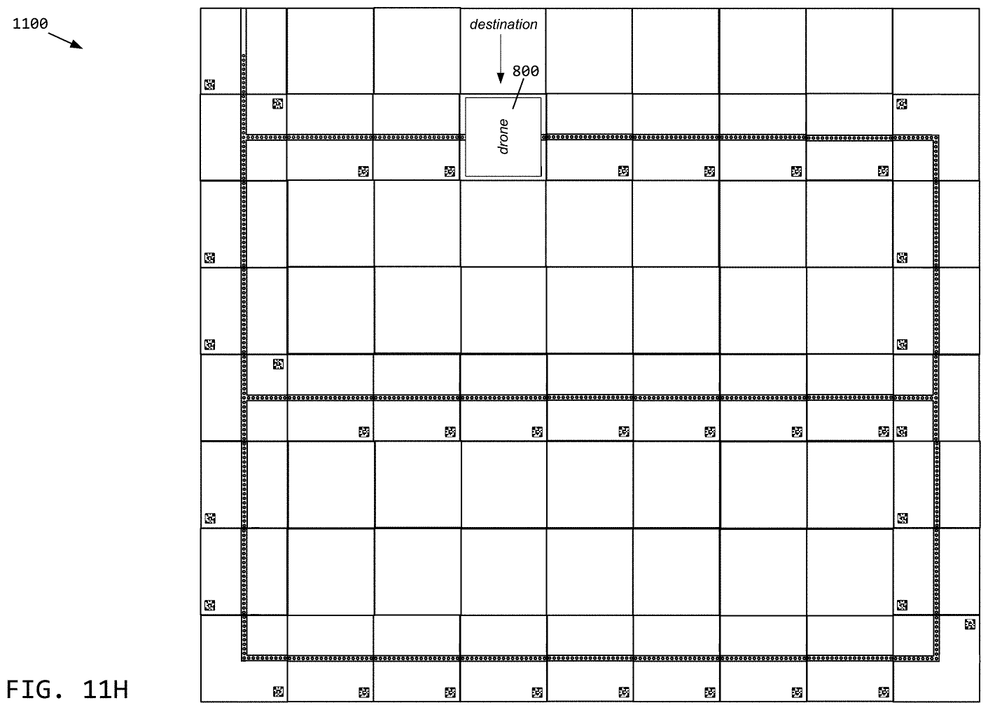

Another system 1100 in accordance with one or more aspects and features of the invention is schematically illustrated in FIGS. 11A through 11H. The system comprises an arrangement of the tiles of FIGS. 4 through 7D that form a floor, and drone 800 for detecting and following illuminated pathways along a floor. The sequence of FIGS. 11A through 11H illustrate navigation of drone 800 in following the pathway illuminated in blue. The drone 800 follows the illuminated pathway to the destination (represented by the end of the illuminated pathway, which is in red and indicates to the drone to stop). The navigation of the drone 800 is controlled by its control unit based on the sensor data that is acquired during the navigation, which includes the detection of the markers whereby the drone 800 knows its position within the mapped floor area of the navigational tiles.

The system 1100 preferably comprises a dispatch system configured to cause a different pluralities of navigational tiles to illuminate different pathways along the floor for drone navigation. Preferably, the dispatch system is disposed in electronic communication with the controllers or switches of the navigational strips for controlling the pathways that are illuminated by the navigational strips. The electronic communication may be wired, wireless, or a combination thereof.

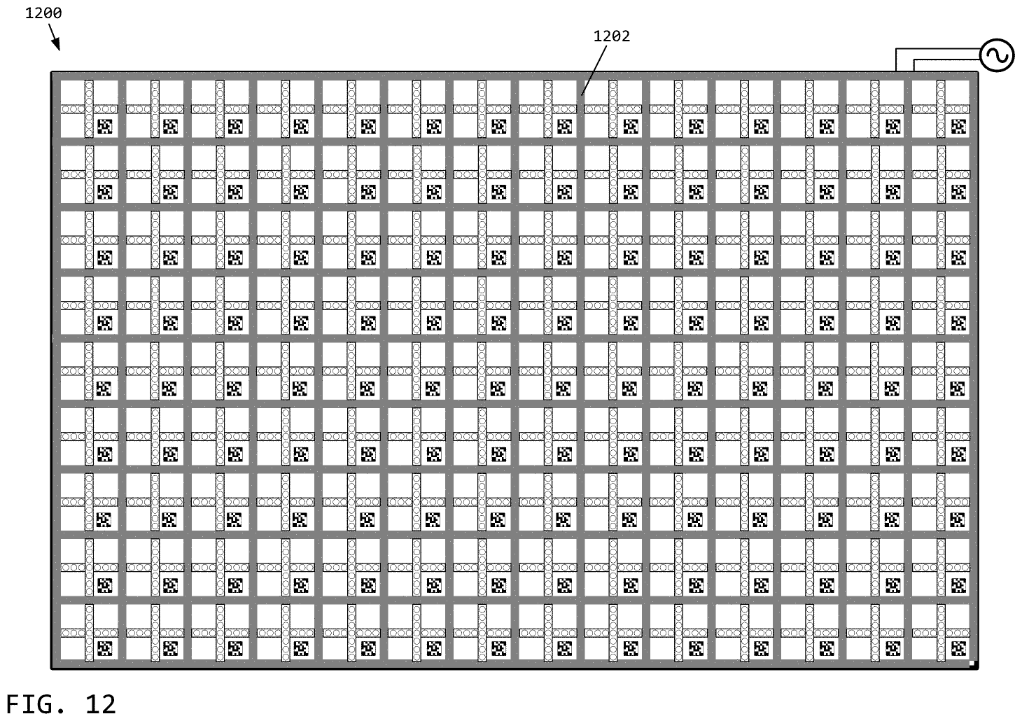

Similar to system 1100, system 1200 of FIG. 12 comprises an arrangement of the tiles of FIGS. 4 through 7D that are configured to selectively illuminate pathways for a drone to follow. Unlike system 1100, the arrange of tiles in the system 1200 form a ceiling for navigation by drones, of which drone 900 is representative. Furthermore, as seen in FIG. 12, the tiles are located within a grid or framework 1202 (shown in gray) for hanging of the tiles to create a “false” ceiling.

The system 1200 preferably comprises a dispatch system configured to cause a different pluralities of navigational tiles to illuminate different pathways along the ceiling for drone navigation. Preferably, the dispatch system is disposed in electronic communication with the controllers or switches of the navigational strips for controlling the pathways that are illuminated by the navigational strips. The electronic communication may be wired, wireless, or a combination thereof.

### Prototypes/Proofs-of-Concept

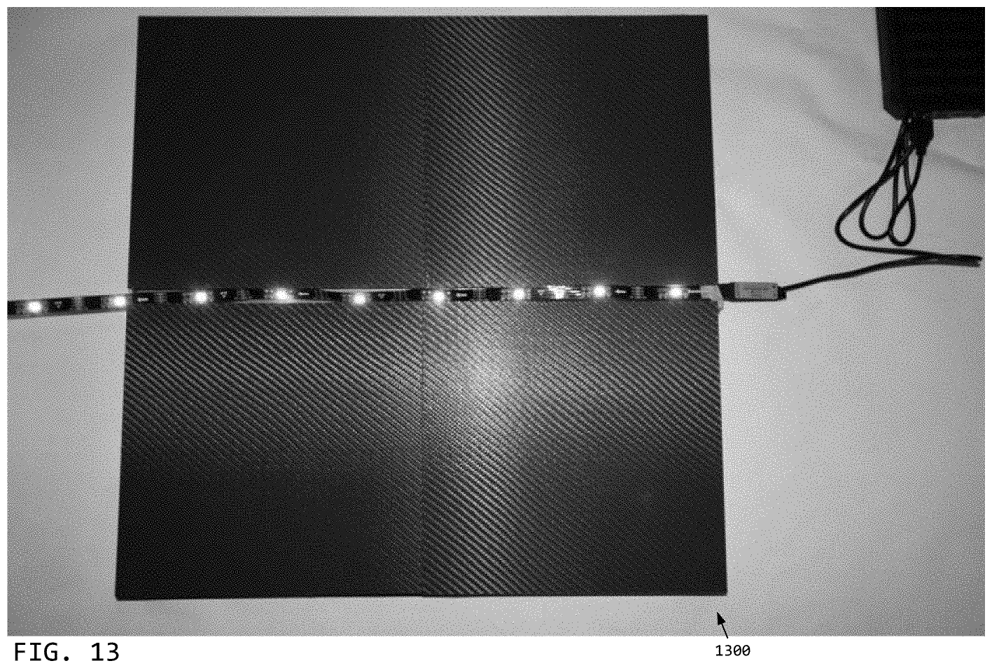

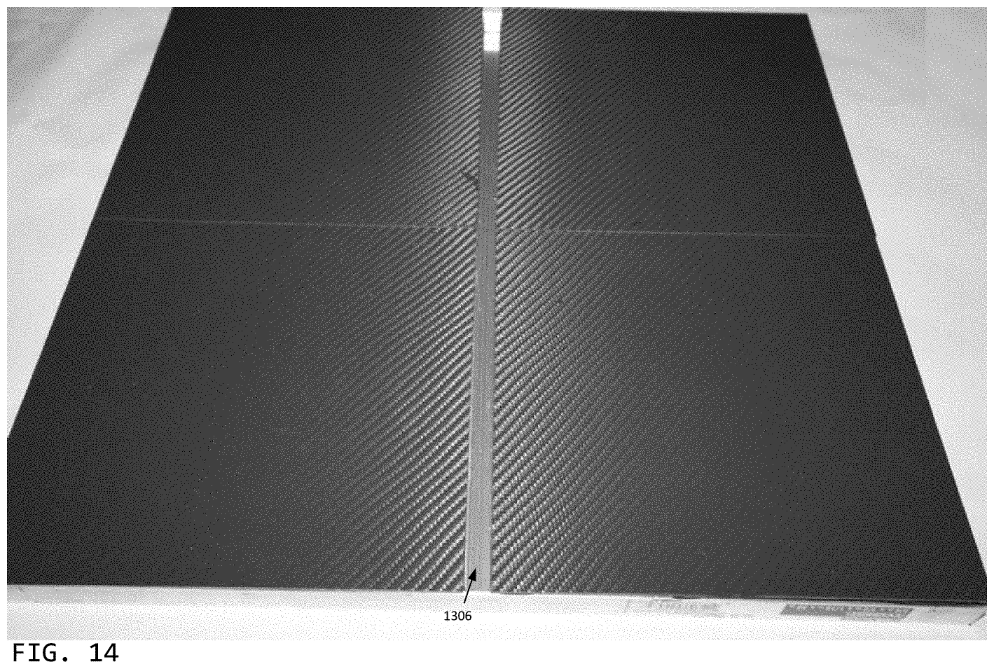

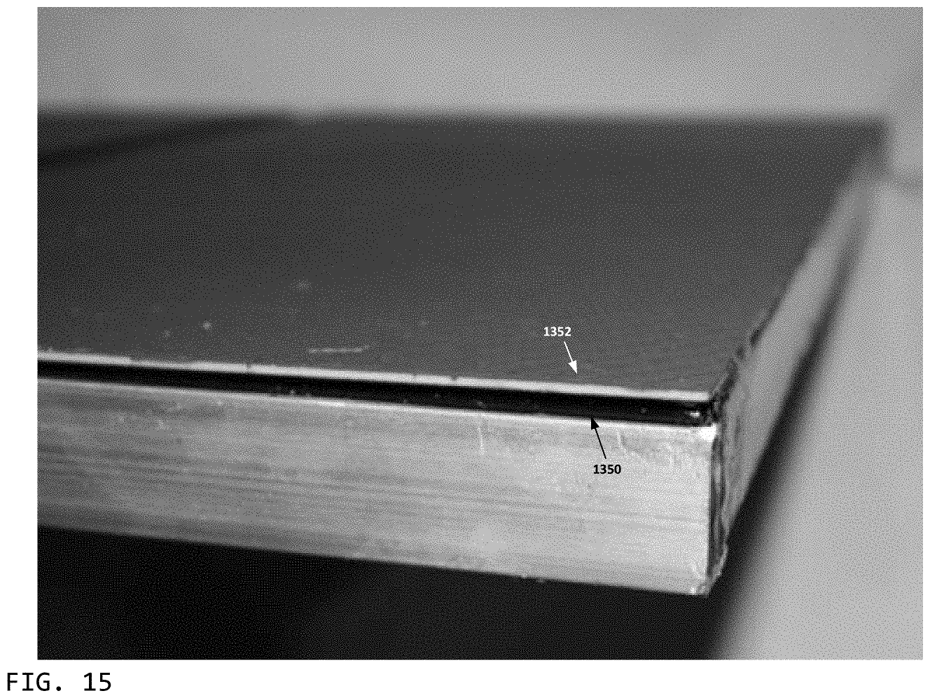

Prototypes/proofs-of-concepts have been made. In this respect, FIG. 13 is a photograph of a prototype tile 1300 having a navigational strip extending across the tile within a channel 1306 of the tile 1300. The navigational strip comprises LEDs that are seen being actuated with electric current from a solar-powered battery pack. FIG. 14 is a photograph of the prototype tile 1300 without the navigation strip, which has been lifted out of the channel. The channel 1306 is 0.25 inches in width, and the tile body comprises aluminum which defines the channel. FIG. 15 is a photograph of a close-up perspective view of a corner of the tile 1300. This view illustrates a Kydex layer 1552 that covers the 0.125 inch thick carbon-fiber plate 1350 that is enhanced with the coating of epoxy resin having the carbon graphene nanoparticles. The aluminum sides of the tile body preferably can be welded or otherwise fastened to other similar tiles for connecting the tiles to form, for example, a floor. Moreover, additional prototypes, proofs-of-concept, and testing are set forth in the appendix.

### Method of Manufacture

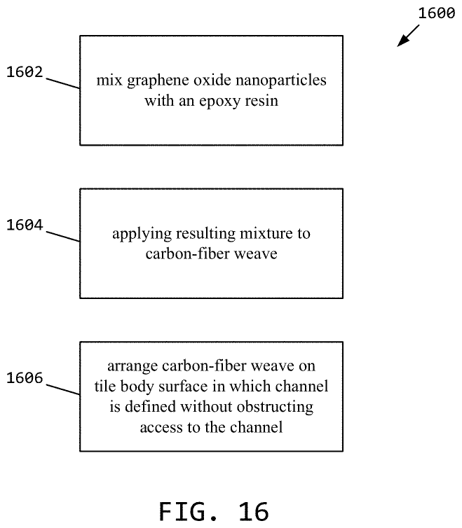

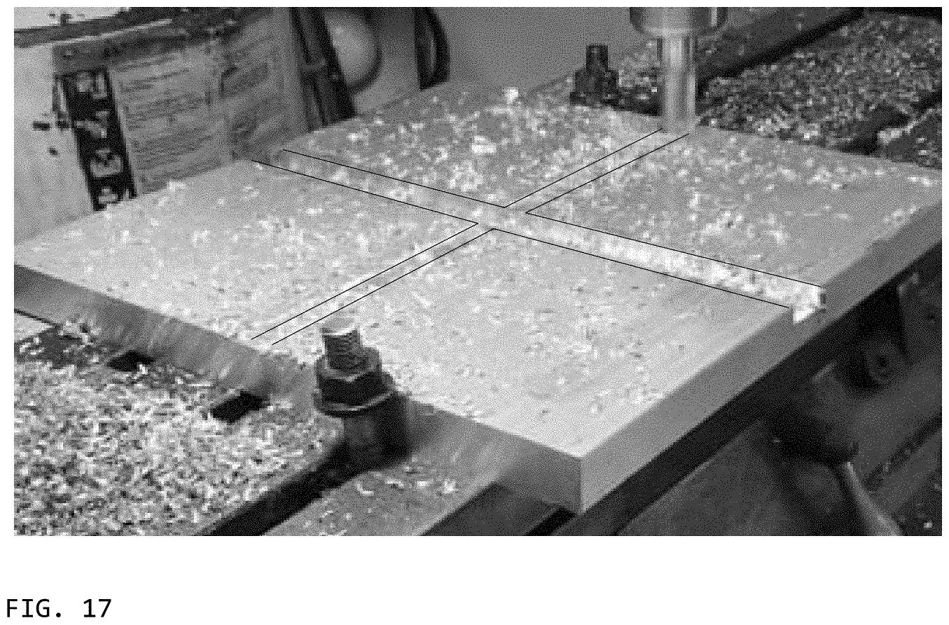

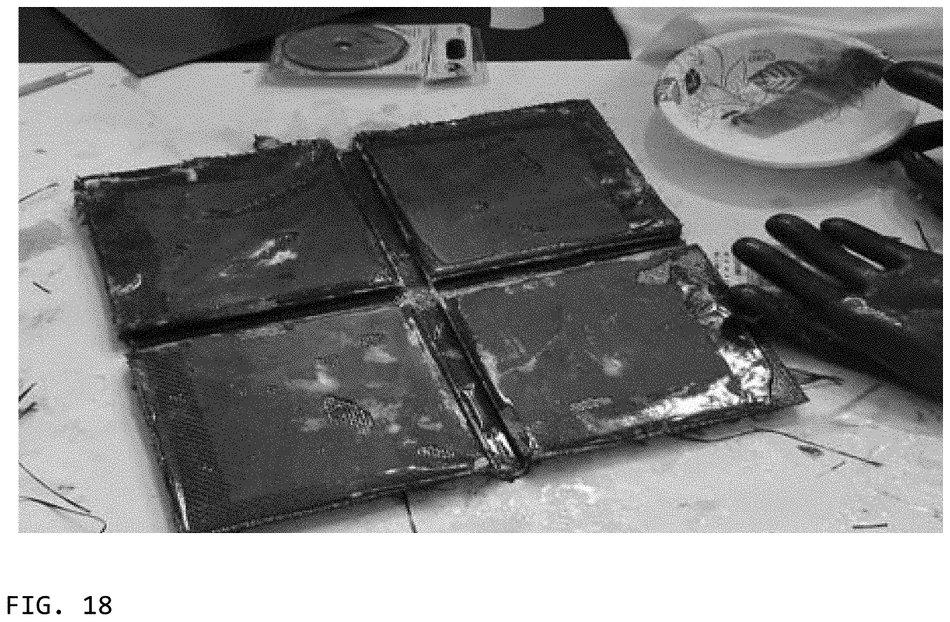

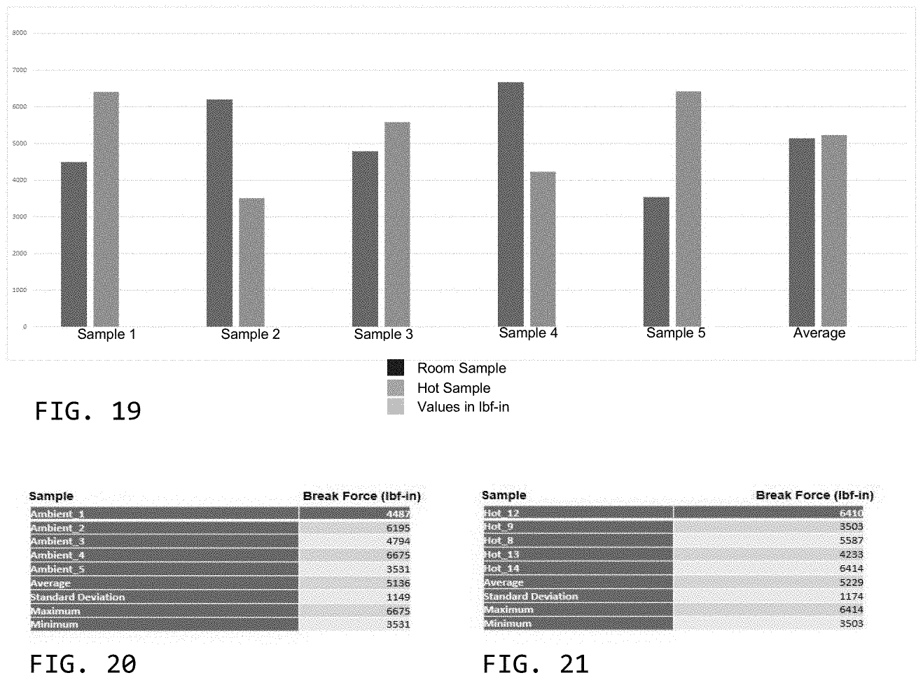

FIG. 16 is a flowchart of a method of manufacturing a preferred tile for use in an autonomous-drone navigation system. The method comprises mixing graphene oxide with an epoxy resin (step 1602); applying the resulting mixture to a carbon-fiber weave to coat the carbon-fiber weave (step 1604); and arranging the carbon-fiber weave on a tile body surface such that access to a channel defined in the tile body surface is not obstructed (step 1606).

During performance of this method 1600, the coated carbon-fiber weave is cured and adhered to the tile surface. Additionally, a sheet of thermoplastic acrylic-polyvinyl chloride may be adhered to the surface of the coated carbon-fiber weave.

After performance of the method 1600, a navigational strip may be located within the channel to extend from a first side to a second side of the tile. The navigational strip may be permanently located—and preferably embedding within a transparent or translucent material—within the channel so as to extend from the first side to the second side of the tile. Alternatively, the navigational strip simply may be laid within the channel during installation of a floor or ceiling using the navigational tiles.

Based on the foregoing description, it will be readily understood by those persons skilled in the art that the present invention has broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Thus, for example, autonomous drones may navigate using the tiles of an embodiment of the invention was well as include, in combination therewith, GPS, cellular, radar, or other conventional navigational techniques. In other words, the invention may supplement or complement conventional navigation by autonomous drones. Additionally, using controllers and switches, select LEDs of a navigational strip can be actuated to illuminate a different light wave than other LEDs of the navigational strip. Thus, a navigational strip may illuminate a “blue” pathway substantially along its extent with the exception of a subset of LEDs along a short distance being actuated to emit a “red” light wave or a “green” light wave thereby sending a command to a drone to stop (when red) or go (when green). It will also be appreciated that tiles may be removably connected to each other and navigational strips inserted in the channels of the connected tiles, whereby a temporary track may be formed for autonomous drone navigations.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A tile comprising a tile body and a high-strength carbon-fiber plate attached to a surface of the tile body, the carbon-fiber plate comprising a cured coating of an epoxy resin having graphene oxide nanoparticles mixed therein, and wherein the tile body defines channel extending from a first side of the tile to a second side of the tile.

2. The tile of claim 1, further comprising a plurality of LEDs extending within the channel and configured to illuminate a pathway for a light wave-detecting sensor.

3. The tile of claim 1, further comprising a plurality of light-emitting components extending within the channel and configured to illuminate a pathway for a light wave-detecting sensor.

4. The tile of claim 1, further comprising a plurality of heat-generating components extending within the channel and configured to illuminate a pathway for a heat-detecting sensor.

5-12. (canceled)

13. The tile of claim 1, wherein the tile comprises on the tile surface a 3D bar code indicative of a location of the tile within a mapped area.

14. The tile of claim 1, wherein a navigational strip extends within the channel from the first side to the second side of the tile.

15. The tile of claim 14, wherein the navigational strip comprises a connector at each end thereof for connections to other navigational strips.

16. The tile of claim 14, wherein the navigational strip further comprises one or more controllers or switches that control actuation of the navigational strip.

17. The tile of claim 14, wherein the navigational strip is configurable for selectively illuminating a pathway when actuated.

18. The tile of claim 17, wherein the pathway that is selectively illuminated is along the entire extent of the navigational strip between sides of the tile body.

19. The tile of claim 17, wherein the pathway that is selectively illuminated is along only a small portion of the entire extent of the navigational strip between sides of the tile body.

20. The tile of claim 19, wherein a plurality of LEDs illuminate the pathway.

21. The tile of claim 19, wherein the pathway is illuminated through generation of heat.

22. The tile of claim 21, wherein the heat is generated from electrical resistance.

23. The tile of claim 1, further comprising a reinforcing layer located on top of the tile body, which reinforcing layer forms the surface of the tile.

24. The tile of claim 23, wherein the reinforcing layer comprises a high-strength carbon-fiber weave having an epoxy resin coating that includes graphene oxide nanoparticles.

25. The tile of claim 23, wherein the reinforcing layer comprises a carbon-fiber plate having an epoxy resin-graphene oxide coating, the reinforcing layer covering the tile body including channel surfaces but not covering access to the channel.

26. The tile of claim 23, further comprising an additional layer located on top of the reinforcing layer.

27. (canceled)

28. The tile of claim 26, wherein the additional layer comprises a sheet of thermoplastic acrylic-polyvinyl chloride, and wherein the tile body comprises an aluminum 6061 plate.

29. The tile of claim 1, further comprising a navigational strip that extends within the channel from the first side to the second side of the tile, and wherein the navigational strip is located below the tile surface, whereby the navigational strip does not support loading of the tile.

30-41. (canceled)
